(19) United States
(12) Patent Application Publication
(10) Pub. No.: US 2009/0194908 A1
(43) Pub. Date: Aug. 6, 2009

(54) MOLD FOR INJECTION MOLDING AND AN INJECTION MOLDING DEVICE/METHOD WITH SURFACE QUALITY IMPROVEMENT ABILITY

(75) Inventors: SHIA-CHUNG CHEN, Taoyuan County (TW); Jen-An Chang, Taoyuan County (TW); Ho-Hsiang Wang, Taoyuan County (TW); Ping-Shun Hsu, Taoyuan County (TW)

Correspondence Address: WPAT, PC, 7225 BEVERLY ST., ANNANDALE, VA, 22003, US

(73) Assignee: CHUNG YUAN CHRISTIAN UNIVERSITY, Taoyuan County (TW)

(21) Appl. No.: 12/131,270

(22) Filed: Jun. 2, 2008

(30) Foreign Application Priority Data
Dec. 28, 2007 (TW) 096150734

(51) Int. Cl. B29C 45/14; B29C 45/03

(52) U.S. Cl. 264/328.1; 425/585

(57) ABSTRACT

A mold for injection molding and an injection molding device/method with surface quality improvement ability are disclosed, in which the injection molding device comprises: a mold including a first mold piece and a second mold piece; and a film feeder. In an exemplary embodiment, the second mold piece is configured with a suction unit in a manner that the film feeder is enabled to provide a film to the suction unit.

### FIELD OF THE INVENTION

The present invention relates to a mold for injection molding and an injection molding device/method with surface quality improvement ability, and more particularly, to an injection molding device and method capable of feeding a film into the mold cavity thereby achieving good surface heat resistance effect.

### BACKGROUND OF THE INVENTION

Generally, in order to enable a melt plastic to flow steadily after it is fed into a mold for injection molding, it is important to keep the temperature of the melt plastic from dropping too fast so that the mobility of the melt plastic can be maintained for preventing the cause of deflect in the resulting products of the injection molding. Therefore, it is commonly seen in those conventional injection molding devices of using a heater to preheat it mold cavity to a specific temperature before injection molding for achieving a purpose of preventing the melt plastic/s temperature from dropping too fast after it is being fed into the mold cavity and thus maintaining it to flow smoothly inside the mold cavity.

There are already many studies relating to the preheating of the mold for injection molding. One of which is a method using the even distribution of high cycle wave magnetism for mold preheating, which is disclosed in TW. Pat. NO. 228945. Another such study is disclosed in TW. Pat. No 224548, in which a heat conducting coil, being a spiral-shaped coil with high cycle induction ability, is sandwiched between a male mold and a female mold for inductively conducting heat directly to the two molds and thus preheating the surfaces of the two in an instant manner, as shown in FIG. 1.

Other than the two aforesaid disclosures, there are techniques of using infrared or electric heating means for mold preheating. However, as the mold used in conventional injection molding are usually made of steel that has good heat conductivity, no matter it is preheated by electric heating, high cycle wave, or infrared means, the surface temperature of the mold is going to drop rapidly during the period between the closure of mold and the injection of plastic into its mold cavity. Consequently, the temperature of the injected plastic can not be maintained which is the cause of poor injection molding. That is, if the mold for injection molding is made of a material with good heat conductivity, the melt plastic in the mold cavity will be affected by the mold and thus it is cooled before it is molded so that defects such as premature failures, overly briquetting pressure, and rough surface could be caused.

### SUMMARY OF THE INVENTION

In view of the disadvantages of prior art, one object of the present invention is to provide an injection molding device/method with surface quality improvement ability, by which the amount of surface defects in its resulting injection molding products can be reduced and thus the surface quality of the resulting products is improved.

To achieve the above object, the present invention provides an injection molding device and method capable of using a process of feeding a film into its mold cavity for achieving good surface heat resistance effect.

Moreover, the present invention further provides a mold device for injection molding, which comprises: a first mold piece; a second mold piece, configured with a suction unit; and a film feeder, for providing a film to the suction unit.

In a first exemplary embodiment of the invention, the film feeder includes a big roller set and a small roller set, in which the diameter of the big roller set is larger than that of the small roller set; and the big roller set, configured with a rolling unit, is attached by a film set in a manner that the film of the film set is enabled to be transferred and disposed on a surface of the suction unit by the rolling of the rolling unit.

In a second exemplary embodiment of the invention, the film feeder is configured with a rotating arm, which has a plate-like structure extending from one end of the rotating arm; and the plate-like structure is configured with a sucker capable of exerting a sucking force that is smaller than an adhering force exerted by the suction unit.

With the aforesaid device and method, the surface temperature dissipating rate of the plastic filled in the mold can be reduced so that the mobility of the melt plastic filled inside the mold can be enhanced while enabling the weld line appeared in a heating area of the resulting injection molding product to fade away.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a sectional view of a preheating structure used in a conventional mold device.

FIG. 2A, FIG. 2B and FIG. 2C are schematic diagrams showing consecutive steps of an operating injection molding device according to a first embodiment of the invention.

FIG. 3A, FIG. 3B and FIG. 3C are schematic diagrams showing consecutive steps of an operating injection molding device according to a second embodiment of the invention.

FIG. 4 shows the temperature variation in a mold without thin layer.

FIG. 5 the temperature variation in a mold with thin layer.

FIG. 6A and FIG. 6B show respectively the surface appearance of molded plastic with and without the use of a thin layer.

FIG. 7A and FIG. 7B are schematic diagrams showing the fading away of weld line on a surface of an injection-molded plastic.

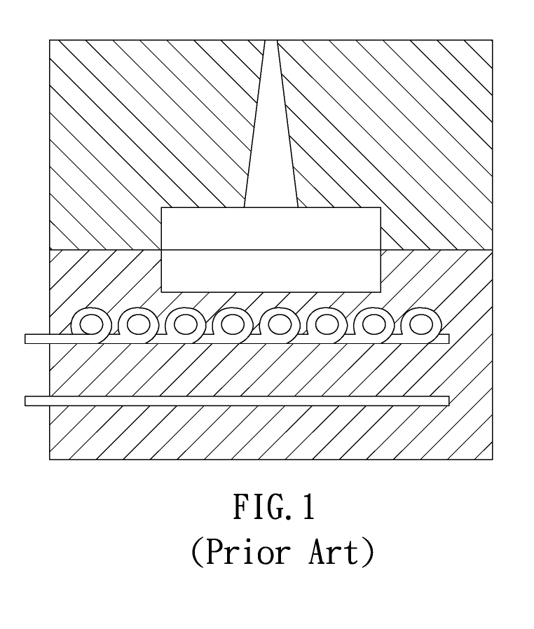

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

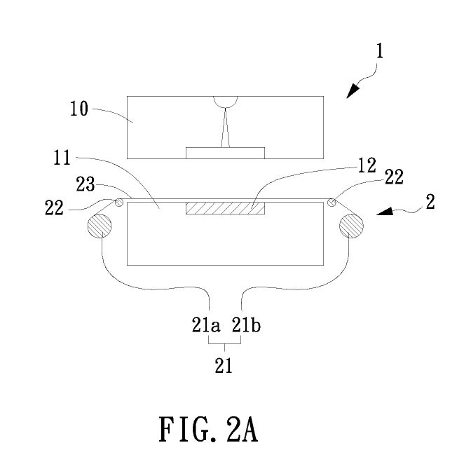

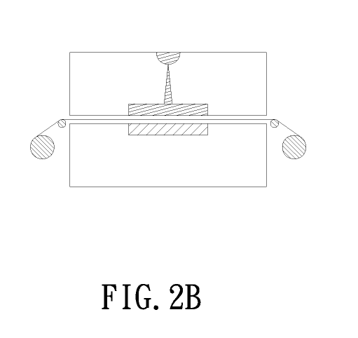

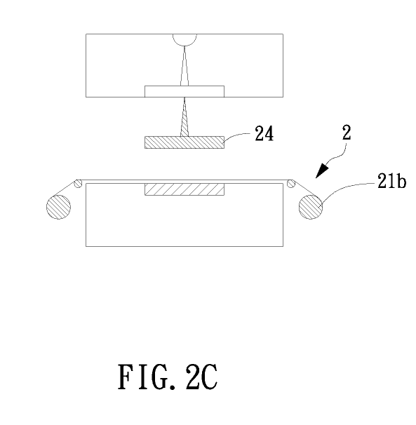

Please refer to FIG. 2A to FIG. 2C, which are schematic diagrams showing consecutive steps of an operating injection molding device according to a first embodiment of the invention. In FIG. 2A, the injection molding device with surface quality improvement ability comprises a mold 1 and a film feeder 2; in which the mold 1 is composed of a first mold piece 10 and a second mold piece 11 having a suction unit 12 configured thereat; and the film feeder 2 is used for providing a film to be attracted by the suction unit 12. It is noted that the suction unit 12 is able to attract the film for enabling the attracted film to adhere flatly on a surface of the mold 1, and the suction unit 12 can be a pneumatic type suction device or an electrostatic type suction device. As shown in FIG. 2A, the film feeder 2, being a roller mechanism, is arranged at positions corresponding to the two sides of the mold 1 so that the film can be driven to move across the surface of the mold 1 by the rolling of the film feeder 2. In FIG. 2A, the film feeder 2 is composed of a big roller set 21 and a small roller set 22 being arranged at positions corresponding to the two sides of the mold 1, in which the big roller set further includes a first big roller 21a and a second big roller 21b. Moreover, there is a film set 23 being mounted on the first big roller 21a whereas the film set 23 can be a roll of film made of polyethylene terephthalate (PET) or composites of polycarbonate (PC). By pulling a front end of the film received in the film set 23 and attaching the front end of the film to the second big roller 21b, the rolling unit fitted to the second big roller 21b is able to drive the film to move with the rotation of the second big roller 21b while the moving film is able to drive the first big roller 21a to rotate accordingly for pulling out unused film from the film set 23 for use in the next injection. Hence, in an injection molding, the operation starts by mounting a film set 23 on the first big roller 21a in a manner that the front end of the film received in the film set 23 is pulled across the surface of the mold 1 and being fixedly attached to the second big roller 21b. Then, the suction unit 12 is activated for attracting the film to adhere flatly on the surface of the mold 1. Thereafter, as shown in FIG. 2B, a mold closing procedure is performed and then a plastic is injected into a mold cavity of the closed mold 1. After the injected plastic is solidified and molded, the mold 1 is opened for taking out the molded plastic 24, as shown in FIG. 2C. Then, for preparing the mold device for next injection molding, the suction unit 12 is turned off while activating the second big roller 21b to rotate until the surface of the mold 1 is covered completely by unused film.

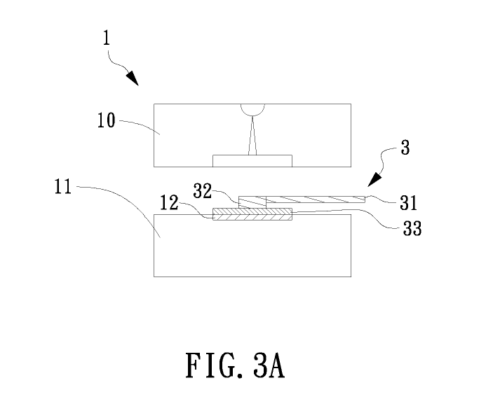

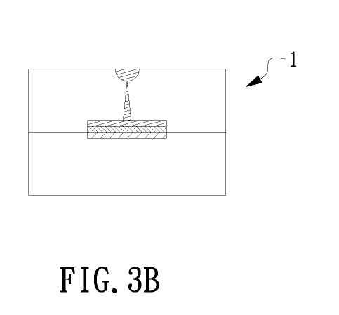

Please refer to FIG. 3A, FIG. 3B and FIG. 3C, which are schematic diagrams showing consecutive steps of an operating injection molding device according to a second embodiment of the invention. In FIG. 3A, the injection molding device with surface quality improvement ability comprises a mold 1 and a film feeder 3; in which the mold 1 is composed of a first mold piece 10 and a second mold piece 11 having a suction unit 12 configured thereat; and the film feeder 3 is used for providing a film to be attracted by the suction unit 12. It is noted that the suction unit 12 is able to attract the film for enabling the attracted film to adhere flatly on a surface of the mold 1, and the suction unit 12 can be a pneumatic type suction device or an electrostatic type suction device. In this second embodiment of the invention, the film feeder 3 has a rotating arm 31 which is configured with a sucker 32 at an extending end of the rotating arm 31. It is noted that the sucker 32 can be a pneumatic type suction device or an electrostatic type suction device while being designed to exert a sucking force that is smaller than an adhering force exerted by the suction unit 12. As shown in FIG. 3A, in an injection molding, the operation starts by providing a film 33 to be sucked by the sucker 32 so that it is then being disposed above a surface of the mold 1 by the rotation of the rotating arm 31; and then the suction unit 12 is activated for attracting the film 33 to adhere flatly on the surface of the mold 1. It is noted that since the adhering force of the suction unit 12 is larger than the sucking force of the sucker 32, the sucker 32 can be maintained ON or can be turned OFF without affecting the adhering of the film 33 on the surface of mold 1. In FIG. 3B, the mold is closed for injecting a plastic into a mold cavity of the mold 1 after the rotating arm 31 is rotated away from the mold 1. In FIG. 3C, after the injected plastic is solidified and molded, the mold 1 is opened for taking out the molded plastic. Thereafter, the suction unit 12 is turned off while enabling the sucker 32 of the rotating arm 31 to pick up the used film 33 for replacing it with unused film so that the injection molding device is ready for next operation.

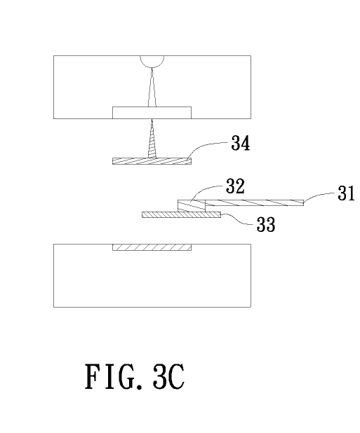

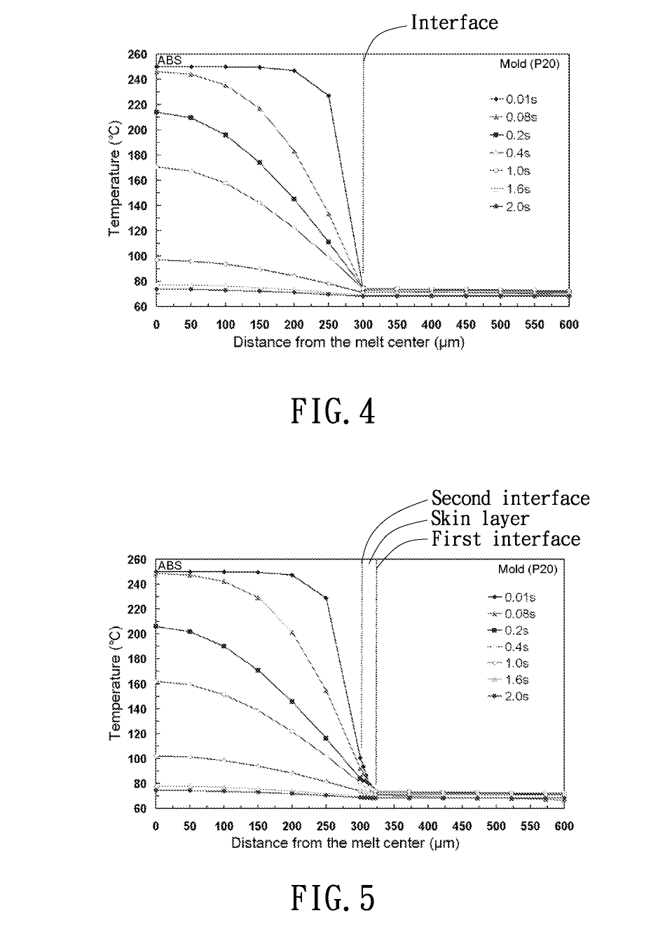

Please refer to FIG. 4 and FIG. 5, which show respectively the temperature variation in a mold without and with a thin layer, for example a thin film. In FIG. 4, the dotted line represents the interface between the plastic and the mold. In FIG. 5, the layer enclosed between the two dotted lines represents the thin layer, which can substantially be a thin film, while the right dotted line is the first interface formed between the thin layer and the mold and the left dotted line is the second interface formed between the plastic and the thin layer. It is noted that the distance between the two dotted lines is the thickness of the thin layer. The curves shown in the two figures profiles the temperature variation of the plastic after it is being injected into the mold. Comparing the curves of the two figures, it is noted that the plastic temperature at distance of 300 μg m in FIG. 5 is much larger than that in FIG. 4. Thus, one can concluded that by the use of thin layer, heat dissipation happening to the injected plastic can be reduced effectively, especially in a short period of time, so that the use of thin layer can prevent the plastic from cooling down too fast before it is molded so that defects such as premature failures, overly briquetting pressure due to reduced mobility of the plastic rising from cold temperature, and rough surface could be avoided.

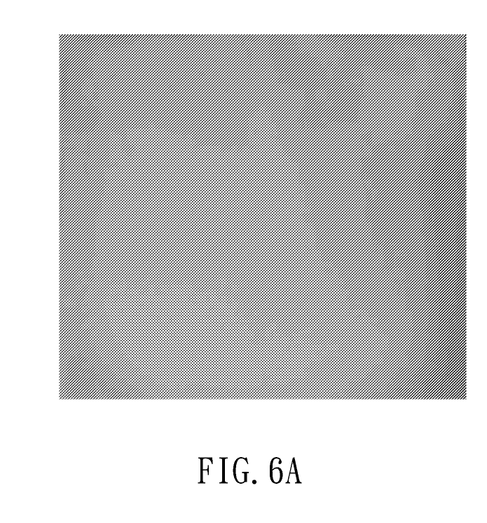

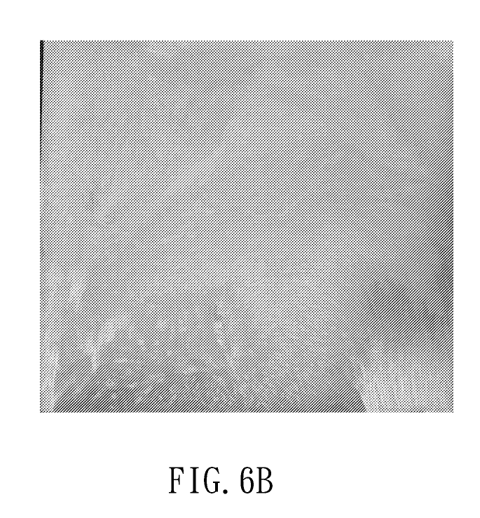

Please refer to FIGS. 6A and 6B, which show respectively the surface appearance of a molded plastic with and without the use of a thin layer. As the use of thin layer is able to promote the mobility of a melt plastic filled inside the mold device since it can prevent the temperature of the melt plastic from dropping too fast by the contacting with the surface of the mold device, “silver crack” on the surface of the molded plastic, caused by the floating of bubble on the plastic's surface when it is moving unsmoothly, can be prevented.

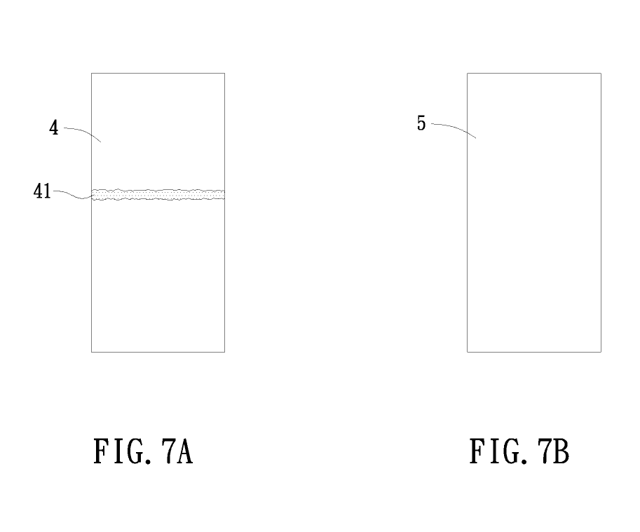

Please refer to FIG. 7A and FIG. 7B, which are schematic diagrams showing the fading away of weld line on a surface of an injection-molded plastic. In FIG. 7A, a molded plastic 4 with a weld line is shown, and in FIG. 7B, another molded plastic 5 is shown which is molded without any weld line. When it is intended to form a product which has larger surface area by the use of an injection mold device with a plurality of injection holes and no thin layer that is a thin film to be provided in its mold cavity, the temperatures at the edges of flowing plastics injected from different injection hole can drop rapidly and thus solidified in short time so that there can be a weld line 41 to be caused at the joint of plastics injected from different injection holes. However, if a thin film is provided in mold cavity at that shown in FIG. 7B, the edges of flowing plastics injected from different injection holes can be maintained while they are joined with each other so that there is no weld line 41 formed on the surface of the resulting molded plastic.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A mold device for injection molding, comprising:
a first mold piece;
a second mold piece, configured with a suction unit; and
a film feeder, for providing a film to the suction unit.

2. The mold device of claim 1, wherein the film is used for reducing the surface temperature dissipating rate of a melt plastic filled inside the mold device.

3. The mold device of claim 1, wherein the film is used for enhancing the mobility of a melt plastic filled inside the mold device.

4. The mold device of claim 1, wherein the film is used for accelerating a weld line appeared in a heating area of a resulting mold device to fade away.

5. An injection molding device with surface quality improvement ability, comprising:
a mold, configured with a suction unit; and
a film feeder, including a big roller set and a small roller set;
wherein the diameter of the big roller set is larger than that of the small roller set; and the big roller set, configured with a rolling unit which is attached by a film set in a manner that the film of the film set is enabled to be transferred and disposed on a surface of the suction unit by the rolling of the rolling unit.

6. The injection molding device of claim 5, wherein the mold further comprises a first mold piece and a second mold piece and the suction unit is set at the second mold piece.

7. The injection molding device of claim 5, wherein the suction unit is a device selected from the group consisting of a pneumatic type suction device and an electrostatic type suction device.

8. The injection molding device of claim 5, wherein the big roller set is composed of a first big roller and a second big roller.

9. The injection molding device of claim 5, wherein the film set is a roll of film.

10. The injection molding device of claim 8, wherein the film set is mounted on the first big roller while fixedly attaching a front end of the film at the second big roller.

11. The injection molding device of claim 8, wherein the rolling unit is configured at the second big roller.

12. An injection molding device with surface quality improvement ability, comprising:
a mold, configured with a suction unit; and
a film feeder, for providing a film and being configured with a rotating arm having a plate-like structure extending from an end of the rotating arm;
wherein the plate-like structure is configured with a sucker capable of exerting a sucking force that is smaller than an adhering force exerted by the suction unit.

13. The injection molding device of claim 12, wherein the mold further comprises a first mold piece and a second mold piece while configuring the suction unit at the second mold piece.

14. The injection molding device of claim 12, wherein the suction unit is a device selected from the group consisting of a pneumatic type suction device and an electrostatic type suction device.

15. The injection molding device of claim 12, wherein the sucker is a device selected from the group consisting of a pneumatic type suction device and an electrostatic type suction device.

16. The injection molding device of claim 12 or claim 5, wherein the film is made of a material selected from the group consisting of polyethylene terephthalate (PET), and composites of polycarbonate (PC).

17. An injection molding method with surface quality improvement ability, comprising the steps of:
(a) mounting a film set on a first roller while attaching an end of the film set to a second roller in a manner that the film received in the film set is enabled to be disposed on a surface of a mold device;
(b) using a suction unit to attract the film for enabling the film to adhere flatly on the surface of the mold device;
(c) closing the mold device and then injecting a plastic into a mold cavity of the mold device;
(d) opening the mold device after the injected plastic is solidified and molded for taking out the molded plastic; and
(e) turning the suction unit off while enabling the second roller to rotate until the surface of the mold device is covered by unused film.

18. The injection molding method of claim 17, wherein after the aforesaid step (e) is completed, the method goes back to the step (b) for repeating the step (b) to the step (e).

19. The injection molding method of claim 17, wherein the suction unit is a device selected from the group consisting of a pneumatic type suction device and an electrostatic type suction device.

20. An injection molding method with surface quality improvement ability, comprising the steps of:
(a) providing a film to be attracted by a sucker so that it is then being disposed above a surface of a mold by the rotation of a rotating arm;
(b) releasing the attracted film from the sucker while initiating a suction unit for enabling the film to adhere on the surface of the mold; and then enabling the rotating arm to rotate away from the mold;
(c) closing the mold and then injecting a plastic into a mold cavity of the mold;
(d) opening the mold after the injected plastic is solidified and molded for taking out the molded plastic;
(e) turning the suction unit off while using the sucker of the rotating arm to remove the film from the surface of the mold.

21. The injection molding method of claim 20, wherein, during the performing of the step (b), the rotating arm is rotated away from the mold at the same time when the film is being released

22. An injection molding method, comprising the steps of:
(a) providing at least a mold;
(b) providing a suction unit to be configured at one of the at least one mold;
(c) providing a film to be attracted by the suction unit;
(d) closing the mold and then injecting a plastic into a mold cavity of the mold;
(e) opening the mold for taking out the molded plastic; and
(f) replacing the film attracted by the suction unit.
